(19) United States
(12) Patent Application Publication
(10) Pub. No.: US 2007/0166433 A1
(43) Pub. Date: Jul. 19, 2007

(54) Synbiotic product and it's application as a carrier of natural bioactive substances in functional food additives

(76) Inventors: Daniela Petrova Peneva, Sofia (BG); Nikola Georgiev Alexandrov, Sofia (BG)

Correspondence Address: SYNNESTVEDT & LECHNER, LLP, 1101 MARKET STREET, 26TH FLOOR, PHILADELPHIA, PA, 19107-2950, US

(21) Appl. No.: 10/582,747

(22) PCT Filed: Dec. 10, 2004
(86) PCT No.: PCT/BG04/00025

§ 371 Date: Jun. 14, 2006

(30) Foreign Application Priority Data
Dec. 15, 2003 (BG) 108449

(51) Int. Cl. A23C 9/12

(52) U.S. Cl. 426/43

(57) ABSTRACT

It used as carrier of bioactive substances of natural origin like dry herb extracts or combinations thereof, other vegetable products as essential oils, fruit concentrates, animal products as bee products, added to vitamins combinations, said product ensuring bacteria proliferation and growth when stored and after intake. The bioactive products can be stored for period 2 to 3 years without the probiotic losing its activity. In the gastroinitestinal tract they can colonize supplying the body with useful substances resulting from their metabolism ensuring fast transportation of bioactive substances to body's cells. It contains low-lactose sour-milk product, low-lactose hydrolyzate with more than 95% degraded milk casein, saccharose, pectin, full-cream or skimmed low-lactose cow's milk fermented using selected strains of Lactobacillus delbrueckii subsp. bulgaricus, and additionally lyophilized monoculture of Lactobacillus delbrueckii subsp. bulgaricus or lyophilized mixture of monocultures of Lactobacillus bulgaricus, Lactobacillus acidophilus, Streptococcus thermophilus, Lactobacillus lactis and dextrose.

### FIELD OF THE INVENTION

The present invention relates to a synbiotic product and to its application as a carrier of natural bioactive substances in functional foods and food additives to ensure a targeted prevention and therapeutic effect on the human body.

### BACKGROUND OF THE INVENTION

A low-lactose sour-milk product including skimmed low-lactose cow's milk fermented using selected strains of Lactobacillus delbrueckii subsp. bulgaricus and containing live sour-milk microorganisms, low-lactose milk hydrolyzate with 95% degraded milk casein, saccharose, pectin, containing in a given embodiment a vitamin complex, found in the composition of probiotic food additives exerting a combined biostimulating effect, in addition to a targeted prevention and therapeutic effect, and containing, in addition to the sour-milk product, a herbal extract such as hypericum, ginseng, and tribulus terrestris extracts or a vegetal product such as rose oil (BG patent applications registration numbers 104 513, 105 453, 105 454, and 105 455).

These products have a shelf life that is determined by the live microorganisms' lifetime. Moreover, since the probiotic effect is dependent on the cell growth in the gastrointestinal tract, the conditions and duration of presence of said microorganisms in the external environment and the gastrointestinal tract should be appropriate enough to maintain the cells' viability, retention, proliferation, and growth. Experience in using these products has shown that the effect sought is not always achieved, most probably owing to some specific characteristics of the individual body that do not allow to achieve retention and proliferation of the probiotic cells and also to inappropriate storage conditions.

On the other hand, phytotherapy uses bioactive substances of vegetal origin, mainly in the form of hot and cold infusions, dry extracts, and tabletted dry plant material.

The problem with phytotherapeutic agents is how to ensure a high level of bioactive substances present in the living body, a satisfactory level of assimilation, and transportation of the bioactive molecules to the cells in the human body.

Therefore, the problems to solve are how to ensure the conditions required for the probiotic cells to remain viable in the external environment, be retained and proliferate in the gastrointestinal tract, obtain the expression of their metabolites, and, at the same time to ensure the vehicles and molecules needed to transport probiotics to the cell receptors in the human body.

### TECHNICAL DESCRIPTION OF THE INVENTION

According to the present invention the above problems are solved through the synthesis of a synbiotic product containing a low-lactose sour-milk product including full-cream or skimmed low-lactose cow's milk, low-lactose milk hydrolyzate with more than 95% degraded milk casein, saccharose, pectin, full-cream or skimmed low-lactose cow's milk fermented using selected strains of Lactobacillus delbrueckii subsp. bulgaricus, a lyophilized monoculture of Lactobacillus delbrueckii subsp. bulgaricus or a lyophilized mixture of monocultures of Lactobacillus bulgaricus, Lactobacillus acidophilus, Streptococcus thermophilus, Lactobacillus lactis and dextrose, in a 1:1:1 ratio of dry sour-milk product:dry bacterial culture:dextrose.

The synbiotic product is used as a carrier of bioactive substances of natural origin such as dry herbal extracts, e.g. hypericum, ginseng, and aloe vera extracts, as well as combinations of dry extracts of various plants and other vegetable products such as essential oils, e.g. lavender oil and rose oil, fruit concentrates (papaya and other fruit concentrates), products of animal origin such as bee products, and vitamins. The products of natural origin should be obtained using techniques that preserve to a maximum the natural character of the bioactive substances they contain, enzymes in particular.

According to the invention, the product ensures bacteria proliferation and growth when stored and after intake. The bioactive products can thus be stored for longer periods, i.e. 2 to 3 years, without the probiotic losing its effect, and, once in the gastrointestinal tract, they can colonize and supply the body with useful substances resulting from their metabolism.

Owing to the high content of free amino acids, the synbiotic product ensures a fast transport of the bioactive substances to the body cells, thus multiplying their effects. At the same time, a powerful probiotic effect is obtained using a mixture of monocultures of various microorganisms—a wider range of substances useful to the body.

Simple sugars obtained through the biotechnological process and the new unknown compounds resulting from their binding to the amino acids of the milk proteins, along with amino acids themselves, create an appropriate environment for storing and keeping the sour-milk microorganisms viable for years under the conditions of the external environment.

### EXAMPLES

### Example 1

### A Synbiotic Product

Composition of a solid dosage form (capsule or tablet) of 400 mg: 150 mg dry low-lactose skimmed sour-milk product, 150 mg of lyophilized monoculture of Lactobacillus delbrueckii subsp. bulgaricus, containing more than 300 million live cells and 10 billion latent cells, and 100 mg of dextrose. It contains proteins-42 mg, carbohydrates-80 mg, fats-0.5 mg, calcium-2 mg, potassium-2.3 mg, phosphorus-1.5 mg, as well as copper, iron, and the natural vitamins of milk. The product promotes a fast and full growth of Lactobacilli in the human body. It produces a beneficial effect by normalizing and regulating microbial flora. It inhibits decay in the stomach and bowels thus preventing a number of severe diseases such as food allergy, ulcerous colitis, constipation, diarrhea, gastrointestinal infections, etc. It has a marked anti-cholesterol effect.

### Example 2

### A Synbiotic Product

Composition of a solid dosage form (capsule or tablet) of 400 mg: 150 mg dry low-lactose skimmed sour-milk product, 150 mg mixture of lyophilized monocultures of Lactobacillus delbrueckii subsp. bulgaricus, Lactobacillus acidophilus, Streptococcus thermophilus, Lactobacillus lactis, containing more than 300 million live cells and 10 billion latent cells, and 100 mg of dextrose. It contains proteins-42 mg, carbohydrates-80 mg, fats-0.5 mg, calcium-2 mg, potassium-2.3 mg, phosphorus-1.5 mg, as well as copper, iron, and the natural vitamins of milk.

### Example 3

### A Synbiotic Product with Dry Extract of Ginseng

Composition of a solid dosage form (capsule or tablet) of 400 mg: 150 mg dry low-lactose skimmed sour-milk product, 150 mg of lyophilized monoculture of Lactobacillus delbrueckii subsp. bulgaricus, containing more than 300 million live cells and 10 billion latent cells, 100 mg of dextrose, and 20 g dry ginseng extract. It contains proteins-42 mg, carbohydrates-80 mg, fats-0.5 mg, calcium-2 mg, potassium-2.3 mg, phosphorus-1.5 mg, as well as copper, iron, and the natural vitamins of milk.

In this case, the probiotic effect combines with those of the bioactive substances of ginseng. The probiotic amino acids are a fast carrier of the biologically active hormone-like substances (gingenosides), essential oil, minerals, and trace elements contained in ginseng. Together with the live Lactobacilli cells, they produce a marked positive effect on ulcer disease.

### Example 4

### A Synbiotic Product with Lavender Oil

Composition of a solid dosage form (capsule or tablet) of 400 mg: 150 mg dry low-lactose skimmed sour-milk product, 150 mg of lyophilized monoculture of Lactobacillus delbrueckii subsp. bulgaricus, containing more than 300 million live cells and 10 billion latent cells, 100 mg of dextrose, and 40 g of lavender oil. It contains proteins-42 mg, carbohydrates-80 mg, fats-0.5 mg, calcium-2 mg, potassium-2.3 mg, phosphorus-1.5 mg, as well as copper, iron, and the natural vitamins of milk.

1. A synbiotic product containing a low-lactose sour-milk product including full-cream or skimmed low-lactose cow's milk, a low-lactose hydrolyzate with more than 95% degraded milk casein, saccharose, pectin, full-cream or skimmed low-lactose cow's milk fermented using selected strains of Lactobacillus delbrueckii subsp. bulgaricus, characterized by the fact of containing a lyophilized monoculture of Lactobacillus delbrueckii subsp. bulgaricus or a lyophilized mixture of monocultures of Lactobacillus bulgaricus, Lactobacillus acidophilus, Streptococcus thermophilus, Lactobacillus lactis and dextrose.

2. A synbiotic product, according to claim 1, characterized by a 1:1:1 ratio of dry sour-milk product: dry bacterial culture: dextrose.

3. Application of the synbiotic product according to claim 1 as a carrier of bioactive substances of natural origin or vitamins as food additives and functional foods.

4. Application, according to claim 2, in which the bioactive substances of natural origin are dry herbal extracts of hypericum, ginseng, or aloe vera, used separately or in combination, other vegetable products such as essential oils, e.g. lavender oil and rose oil, as well as fruit concentrates such as papaya concentrate, in addition to combinations of said natural substances.
